(19) United States
(12) Patent Application Publication
(10) Pub. No.: US 2010/0168919 A1
(43) Pub. Date: Jul. 1, 2010

(54) CONTROL METHOD AND CONTROL SYSTEM FOR MANIPULATOR

(75) Inventor: Tamao Okamoto, Hyogo (JP)

Correspondence Address: WENDEROTH, LIND & PONACK L.L.P., 1030 15th Street, N.W., Suite 400 East, Washington, DC, 20005-1503, US

(73) Assignee: MATSUSHITA ELECTRIC INDUSTRIAL CO, LTD., Osaka (JP)

(21) Appl. No.: 11/993,664

(22) PCT Filed: Mar. 23, 2007
(86) PCT No.: PCT/JP2007/056023

§ 371 Date: Dec. 21, 2007

(30) Foreign Application Priority Data
Mar. 24, 2006 (JP) 2006-082269

(51) Int. Cl. B25J 9/10

(52) U.S. Cl. 700/275; 700/302

(57) ABSTRACT

In a control method of a multi-jointed manipulator, the manipulator is controlled through a process to transmit a difference between an end position of the manipulator and a target position to the joint axes, and a process to adjust joint displacements and joint velocities of the joint axes independently of one another of the joint axes based on the difference, these processes being repeated until the end position coincides with the target position. By such a manipulator control method, there can be realized position control which is robust against ambient environments and which is easy to achieve even with redundancy or nonlinear drive elements involved.

### BACKGROUND OF THE INVENTION

1. Technical Field

The present invention relates to a technique of controlling a multi-jointed manipulator.

2. Description of Related Art

Multi-jointed manipulators have been used in robot arms or the like of industrial or consumer use. Various techniques are already available in association with position control for such manipulators.

As an example, there is a technique using inverse kinematics in which displacements or driving forces of respective joint axes for achieving specific end-point position of a manipulator are determined by computation of inverse kinematics to allow the control to be performed based on the resulting displacement or driving forces.

An example of this related art technique using inverse kinematics is explained with reference to FIGS. 19 and 20. FIG. 19 is a view showing an outline of a manipulator control method according to a related art, and FIG. 20 is a control processing flowchart of a manipulator according to the related art.

Referring to FIG. 19, mounted on joint axes 511 of the manipulator 501, respectively, are sensors 502 (sensors S) such as encoders, and actuators 503 (actuators A) for driving joint axes 511. By using these sets, a hand end 504 of the manipulator 501 is position-controlled with respect to a control target 505 (control target G). The manipulator 501 comprises a total control section 506, and the total control section 506 calculates control command values of the actuators 503 with use of results measured by the sensors 502. In addition, the total control section 506 has three processing sections comprised of a total evaluation processing section 507, a trajectory plan processing section 508, and a control computation processing section 509. The hand end 504 is position-controlled up to the control target 505 as shown by a control trajectory 510.

Referring to FIG. 20, first in the control processing flow, at step S51, displacements (joint displacements) and displacement velocities (joint velocities) for the joint axes 511 are measured by the sensors 502 mounted on the joints, respectively. Next at step S52, from information as to displacements and displacement velocities collected from the individual joint axes 511, position of the hand end 504 are calculated. Subsequently at step S53, a hand-end trajectory 510 for movement to the target position 505 is calculated. At step S54, control command values for displacements and displacement velocities of the respective joint axis 511 for achieving the target trajectory 510 are calculated. at step S55, the actuators 503 of the joint axes 511 are driven so that the control command values are achieved. Until the hand end 504 of FIG. 19 reaches the control target 505, processing of such steps S51-S55 is iteratively executed. As for the relationship between the control processing of FIG. 20 and the control elements of FIG. 19, the step S51 is executed by the sensors 502, the step S52 is executed by the total evaluation processing section 507, the step S53 is executed by the trajectory plan processing section 508, the step S54 is executed by the control computation processing section 509, and the step S55 is executed by the actuators 503.

In this case, a calculation equation to be generally applied for calculation of position of the hand end 504 in step S52 is expressed as shown by Equation (1):

H=T(θ) (1)

Equation (1) is called kinematic equation for link mechanisms, where H represents a position vector of the hand end and θ represents a displacement vector of the joint axis.

Also, in step S54, a calculation equation generally applied for calculation of displacement-velocity control commands can be expressed as shown by Equation (2):

θc=T−1(Ho) (2)

Equation (2) is called inverse kinematic equation for link mechanisms, where Ho represents a target position vector of the hand end for achieving a target trajectory and Δc represents a displacement vector of the joint axis for achieving the target position vector of the hand end. However, since there are some problems, for example, that Equation (2) cannot be uniquely solved for redundant control systems, other calculation methods may be used, in some cases, instead of Equation (2) (see, e.g., Patent Documents 1 and 2).

Related art examples disclosed in Patent Documents 1 and 2 are explained with reference to FIGS. 21A, 21B and 22. In this case, FIG. 21A a control process flowchart of a manipulator according to the related art, FIG. 21B is a view showing a control method for limiting the number of driven joints in the manipulator control according to a related art, and FIG. 22 is a view showing a control method for a manipulator according to a related art.

In the control method disclosed in Patent Document 1, displacements of the joint axes for achieving hand end position of the manipulator are determined by using either one of two methods as shown in FIGS. 21A and 21B. In the case of FIG. 21A, in a redundant manipulator 520, a displacement 522 is determined by uniform distribution of displacements for the joint axes 521, respectively. On the other hand, in the case of FIG. 22B, joint axes 523 to be driven out of the joint axes 521 are selected only by necessary dimensions, so that the redundant manipulator 520 is made nonredundant in terms of control, thus enabling the computation of displacements for the joint axes 521.

In the control method disclosed in Patent Document 2, a control section is compelled to do training of inverse kinematics relations so that driving force for an actuator can be calculated. In FIG. 22, a torque T is calculated by a computing unit 534 from an error between a target trajectory Pd and an actual trajectory P, and then the actuator 535 is driven with the torque T. In this process, a result of passage of the target trajectory Pd through a differential circuit 536 as well as the torque T are inputted to a neural network 537, by which a training of the multilayer neural network 537 is performed, and an output, which is a training result, is added to the torque T and then inputted to the actuator 535, thus the control being fulfilled.

There are other methods for performing distributed control without using inverse kinematics (see, e.g., Patent Documents 3, 4).

Related art examples disclosed in Patent Documents 3 and 4 are explained with reference to FIGS. 23 and 24. FIG. 23 is a view showing a control method disclosed in Patent Document 3, and FIG. 24 is a view showing a control method disclosed in Patent Document 4.

In the control method disclosed in Patent Document 3, the manipulator performs control by using partial differentiation of a multivariable evaluation function for each joint angle. Referring to FIG. 23, first, the manipulator 540 sets a multivariable evaluation function 542 by using joint angles θ1, θ2 for individual joints 541 which are under a control operation for movement on a trajectory 549. Subsequently, by using a joint-angle partial differentiation 543 derived from partial differentiation of the multivariable evaluation function 542 by each angular variable at a given time point, the manipulator 540 performs control over the joints 541 in such a distributed manner that the multivariable evaluation function 542 satisfies specified conditions.

Referring to FIG. 24, in the method of Patent Document 4, a control unit performs control by using a joint-part load threshold corresponding to a position of a manipulator end. A position of the manipulator detected by a position detection unit 553 is measured, a load threshold according to the measured position information is selected by an operation control unit 554, and actuators 557 are controlled in a distributed manner by using joint-angle servo drivers 556 so that load detectors 555 provided for individual joint angles have the load threshold.

It has been the case that such control using inverse kinematics or distributed control as shown above is performed to fulfill position control of multi-jointed manipulators.

Patent Document 1: Japanese patent application publication No. H07-164360

Patent Document 2: Japanese patent application publication No. H02-054304 A

Patent Document 3: Japanese patent application publication No. H09-207087 A

Patent Document 4: Japanese patent application publication No. 2000-094368 A

However, the conventional control methods, when applied to manipulators that perform operations demanding higher degrees of freedom, encounter the following issues.

The conventional method using inverse kinematics, although applicable to manipulators which are nonredundant and have no nonlinear elements, yet may be incapable of working for intended operations depending on environments. This is because a manipulator state is uniquely determined so that the hand end is disabled from reaching a target position. On the other hand, with redundancy or nonlinear drive elements incorporated for enhancement of the degree of freedom for operations, the inverse kinematic equation, Equation (2), becomes too complicated to uniquely solve, which may lead, in some cases, to an impossibility of control or an enormous quantity of computations that makes it impossible to fulfill real-time control.

In the case of Patent Document 1, constraint conditions are provided for a redundant manipulator by making use of its configuration or reduction in its degree of freedom so as to enable its control. However, since the degree of freedom is limited by the constraint conditions in one aspect, there is a possibility that the workability of the manipulator may be limited. Also, in the case of Patent Document 2, it is possible, by the training of the multilayer neural network, to solve the redundancy, the computational problems due to nonlinear drive elements, or the robustness. However, without any proper setting of parameters or teaching data, it can occur that the training takes much time or computation results do not converge, resulting in a difficulty in adaptation.

Further, in the methods using inverse kinematics, since displacements or driving forces for all the joints for the reach to a control target is uniquely determined in either case, an occurrence of immobility of one joint due to effects of ambient environments or some failure could make it impossible to fulfill the total position control.

Patent Document 3 is capable of distributed control uniform over the individual joints independent of the configuration of the manipulator. However, the evaluation function or computation processing therefor needs to be set according to the configuration of the manipulator or the contents of its working operation, where it can be the case that the working operation cannot be fulfilled depending on the evaluation function. Also, Patent Document 4 is capable of performing distributed control uniform over the individual joints independently of the configuration of the manipulator. However, since the load on a joint varies depending not only on the position and posture but also on the trajectory or the tool to be set on the manipulator in working or the like, there is a need for preliminarily registering load thresholds for the joints by teaching or training for each working operation, so that unexpected circumstances could not be managed.

These and other issues associated with manipulator control would occur not only when position control for the hand end of the manipulator is performed but also when force control for the hand end is performed.

Accordingly, an object of the present invention, lying in solving the above-described issues, is to provide a control method and a control system for manipulators capable of easily and flexibly achieving the control even with redundancy or nonlinear drive elements involved, independently of such uncertainties as ambient environments or failures of the joint axes.

### SUMMARY OF THE INVENTION

In accomplishing the above object, the present invention has the following constitutions.

According to a first aspect of the present invention, there is provided a control method for a manipulator having a plurality of joint axes, comprising:

a first step for measuring a difference between a parameter and a target value for an end portion of the manipulator;

a second step for transmitting joint information including joint displacements and joint velocities of the plurality of joint axes, and difference information bearing the difference, to joint control sections for the joint axes, respectively; and

a third step for correcting parameters of the joint axes independently of one another by the joint control sections, respectively, based on the joint information and the difference information, wherein

the first to third steps are iterated until the parameter of the end portion reaches to within a set range including the target value.

According to a second aspect of the present invention, there is provided a control method for a manipulator having a plurality of joint axes, comprising:

a first step for measuring a positional difference between an end position of the manipulator and a target position;

a second step for transmitting joint information including joint displacements and joint velocities of the plurality of joint axes, and positional difference information bearing the positional difference, to joint control sections for the joint axes, respectively; and

a third step for correcting the joint displacements and the joint velocities of the joint axes independently of one another by the joint control sections, respectively, based on the joint information and the positional difference information, wherein

the first to third steps are iterated until the end position reaches to within a set range including the target position.

According to a third aspect of the present invention, there is provided the control method for a manipulator as defined in the second aspect, wherein

based on the information as to the joint displacements and joint velocities acquired from the plurality of joint axes, the joint information including the joint displacements and joint velocities of the plurality of joint axes is prepared on the joint axis basis, and

thereafter, the second step is executed.

According to a fourth aspect of the present invention, there is provided the control method for a manipulator as defined in the second aspect, wherein

in the second step, information including a Jacobian matrix computed by using the joint displacements and the joint velocities as well as an end velocity of the manipulator is transmitted on the joint axis basis, while information as to a deviation vector of the end position with respect to the target position is transmitted as the positional difference information on the joint axis basis,

in the third step, by using the end velocity, the joint velocities of the joint axes, and the Jacobian matrix, a motion vector for the end position is computed based on the joint velocity vectors of the joint axes, and the joint velocity vector is corrected on the joint axis basis so that the motion vector approaches the deviation vector.

According to a fifth aspect of the present invention, there is provided the control method for a manipulator as defined in the second aspect, wherein

in the second step, information including information as to a velocity ratio of an upper-limit value of an end velocity to an actual end velocity, the end velocity being set in correspondence to a distance between the end position and the target position, is transmitted to the joint axes, and

in the third step, the joint velocities are corrected on the joint axis basis in response to the velocity ratio by the plurality of joint control sections.

According to a sixth aspect of the present invention, there is provided the control method for a manipulator as defined in the third aspect, wherein

when all of acquired joint velocities of the joint axes are 0, the position of the target position or the joint velocity is temporarily changed, and

thereafter, the second step is executed.

According to a seventh aspect of the present invention, there is provided the control method for a manipulator as defined in the second aspect, wherein

acquired identification information as to joints owned by the joint axis is unified, by which a change in connection states of the plurality of joint axes is detected.

According to an eighth aspect of the present invention, there is provided the control method for a manipulator as defined in the second aspect, wherein after identification information as to the plurality of joint axes is transmitted from the total control section to the plurality of joint control sections, control for the joint axes is executed in the plurality of joint control sections only when previously stored identification information as to the joint control sections' own joints coincides with the transmitted identification information.

According to a ninth aspect of the present invention, there is provided a control method for a manipulator having a plurality of joint axes, comprising:

a first step for measuring a force difference between a contact force applied to an end portion of the manipulator and a target contact force;

a second step for transmitting joint information including joint displacements and joint velocities of the plurality of joint axes, as well as force difference information bearing the force difference, to joint control sections for the joint axes, respectively; and

a third step for, based on information including the joint displacements and the joint velocities of the plurality of joint axes as well as on information bearing the force difference, correcting the joint displacements and the joint velocities for the joint axes in the joint control sections independently of one another on the joint axis basis, wherein

the first to third steps are iterated until the contact force applied to the end portion reaches to within a set range including the target contact force.

According to a tenth aspect of the present invention, there is provided the control method for a manipulator as defined in the ninth aspect, wherein

based on the information as to the acquired joint displacements and joint velocities of the plurality of joint axes, the information including the joint displacements and the joint velocities of the plurality of joint axes is prepared on the joint axis basis; and

thereafter, the second step is executed.

According to an 11th aspect of the present invention, there is provided the control method for a manipulator as defined in ninth aspect, wherein

in the first step, a positional difference between a position of the end portion and a target position is further measured,

in the second step, information including a Jacobian matrix computed by using the joint displacements and the joint velocities as well as information including an end velocity of the manipulator is transmitted to the plurality of joint axes, while information as to a deviation vector of the end portion with respect to the target position and a target contact force is prepared, and information as to a total difference which is a result of adding to the positional difference an equivalent positional difference obtained by equivalently converting the force difference into a positional difference is transmitted, and

in the third step, by using the end velocity, the joint velocities of the joint axes, and the Jacobian matrix, a motion vector for the end position is computed based on the joint velocity vectors of the joint axes, and the joint velocity vectors are corrected on an joint axis basis so that the motion vector approaches the deviation vector.

According to a 12th aspect of the present invention, there is provided a control system for a manipulator having a plurality of joint axes, comprising:

a measuring device for measuring a difference between a parameter and a target value for an end portion of the manipulator;

a total control section for controlling the manipulator based on the difference information and information including joint displacements and joint velocities of the plurality of joint axes;

a transmission device for transmitting evaluation result information as to the control from the total control section to the plurality of joint axes; and

a plurality of joint control sections which are provided on the plurality of joint axes, respectively, for correcting parameters of the joint axes independently of one another of the joint axes based on the transmitted evaluation result information thereby controlling driving of the joint axes.

According to a 13th aspect of the present invention, there is provided a control system for manipulator having a plurality of joint axes, comprising:

a measuring device for measuring a positional difference between an end position of the manipulator and a target position;

a total control section for controlling a position of the manipulator based on information bearing the positional difference and information including joint displacements and joint velocities of the plurality of joint axes;

a transmission device for transmitting the position control information from the total control section to the plurality of joint axes; and

a plurality of joint control sections which are provided on the plurality of joint axes, respectively, for correcting the joint displacements and the joint velocities of the joint axes independently of one another of the joint axes based on the transmitted position control information thereby controlling driving of the joint axes.

According to a 14th aspect of the present invention, there is provided the control system for a manipulator as defined in the 13th aspect, wherein the total control section comprises:

a storage device for storing therein joint information including identification information or morphological information as to the joint axes;

a monitoring device for monitoring connection states of the plurality of joint axes based on the joint information stored in the storage device; and

a joint information updating device for updating the joint information stored in the storage device when a change in the connection states of the plurality of joint axes is detected by the monitoring device.

According to a 15th aspect of the present invention, there is provided the control system for a manipulator as defined in the 13th aspect, wherein each of the joint control sections comprises:

a storage device for storing therein joint information including identification information or morphological information as to the joint axes; and

a communication device for notifying the total control section of the joint information stored in the storage device by any of the joint axes being connected to another joint axis.

According to a 16th aspect of the present invention, there is provided a control system for a manipulator having a plurality of joint axes, comprising:

a measuring device for measuring a force difference between a contact force applied to an end portion of the manipulator and a target contact force;

a total control section for performing torque control for the manipulator based on information bearing the force difference and information including joint displacements and joint velocities of all the joint axes;

a transmission device for transmitting the torque control information from the total control section to the plurality of joint axes; and

a plurality of joint control sections which are provided on the plurality of joint axes, respectively, for correcting the joint displacements and the joint velocities of the joint axes independently of one another of the joint axes based on the transmitted torque control information thereby controlling driving of the joint axes.

According to the control method and the control system of manipulators in the present invention described above, since the position control for a control target (a specified range including a control target) is performed independently on a joint-to-joint basis, there occurs neither the problem that the control command value involved in inverse kinematics cannot be uniquely determined nor the problem due to large quantities of computations, even in a manipulator having redundancy or nonlinear drive elements. Thus, the position control of the manipulator can be carried out with reliability.

Also, since there is no need for setting constraint conditions for the computation of inverse kinematics or for limiting the degree of freedom, the control can be carried out while a high degree of freedom is maintained. Furthermore, since the training by data storage is unnecessary as well, the manipulator control can be carried out with ease.

Further, even if some of the articulation joints are disabled from operation due to effects of the ambient environments or failures of the joints, the redundancy is naturally exercised by the other joints individually going toward the control target, making it possible to achieve the control independent of such uncertainties as the ambient environments or failures of the articulation joints.

Consequently, there can be provided a control method and a control system for manipulators capable of easily and flexibly achieving the control even with redundancy or nonlinear drive elements involved, independently of such uncertainties as ambient environments or joint failures.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a schematic view of a manipulator according to a first embodiment of the present invention;

FIG. 2 is a schematic view of a control system of the first embodiment;

FIG. 3 is a chart showing a control processing flow of the first embodiment;

FIG. 4 is a conceptual view of operation of the control system of the first embodiment;

FIG. 5A is a schematic view showing a positional relation between a manipulator hand and a control target;

FIG. 5B is a schematic view showing a way of determining command values for individual joint axes of the manipulator;

FIG. 6 is a schematic view showing a way of setting an upper limit of the hand velocity of the manipulator in the first embodiment;

FIG. 7A is a schematic view for explaining a problem when the manipulator has come into a singular posture;

FIG. 7B is a schematic view showing a first management method of escape of the manipulator from the singular posture;

FIG. 7C is a schematic view showing a second management method for escape of the manipulator from the singular posture;

FIG. 8 is a schematic view of a manipulator control system according to a second embodiment of the invention;

FIG. 9 is a schematic view showing a state prior to a change of a component element of the manipulator;

FIG. 10 is a schematic view showing a state after a change in the component element of the manipulator and until a detection of the changed point;

FIG. 11 is a schematic view showing a state in which a parameter inquiry to the joint control sections is going on;

FIG. 12 is a schematic view showing a state in which a parameter response from the joint control sections is going on;

FIG. 13 is a schematic view showing a state in which normal control is carried out under recognition of a constituent-element change in the manipulator;

FIG. 14 is a schematic view of a control system for a manipulator according to a third embodiment of the invention;

FIG. 15 is a chart showing a control processing flow of the third embodiment;

FIG. 16 is a conceptual view of operation of the control system in the third embodiment;

FIG. 17 is a schematic view of explaining an evaluation method in control of the manipulator;

FIG. 18 is a schematic view of a manipulator according to a modification of the first embodiment;

FIG. 19 is a view showing an outline of a manipulator control method according to a related art;

FIG. 20 is a control processing flowchart of a manipulator according to the related art;

FIG. 21A is a view showing a control method of uniformly distributing a bending angle in the manipulator control according to the related art;

FIG. 21B is a view showing a control method of limiting the number of driven joints in the conventional manipulator control;

FIG. 22 is a view showing a control method of a manipulator according to a related art;

FIG. 23 is a view showing a control method of a manipulator according to a related art; and

FIG. 24 is a view showing a control method of a manipulator according to a related art.

### DETAILED DESCRIPTION OF THE PREFERRED EMBODIMENT

Before the description of the present invention proceeds, it is to be noted that like parts are designated by like reference numerals throughout the accompanying drawings. Herein below, embodiments of the present invention will be described in detail with reference to the accompanying drawings.

### First Embodiment

Herein below, a control system of a manipulator according to a first embodiment of the present invention, as well as its control method, will be described with reference to the accompanying drawings.

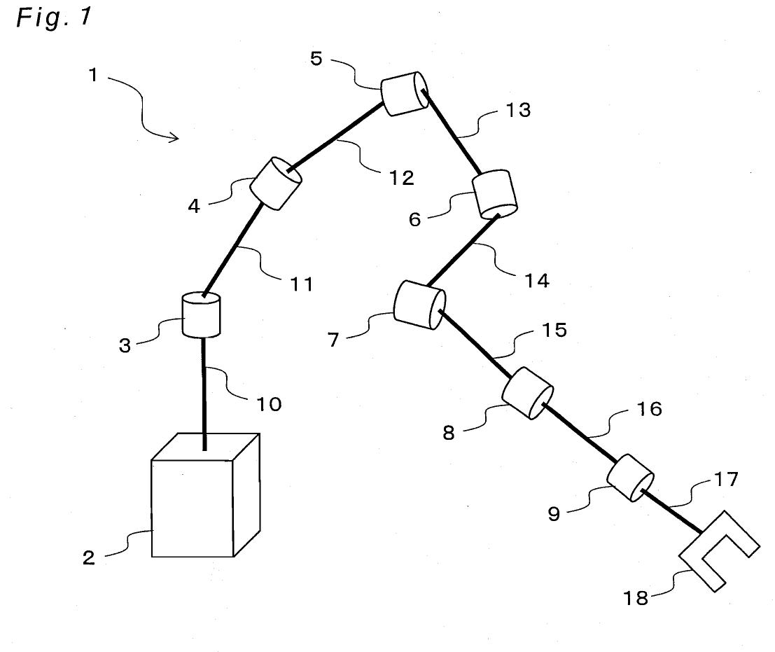

FIG. 1 is a schematic view of a manipulator according to a first embodiment of the invention. As shown in FIG. 1, the manipulator 1 comprises seven joint axes 3-9, eight links 10-17 for connecting the joint axes to one another, a base 2 for supporting the joint axes 3-9 in series via the link 10, and a hand (end portion or hand end) 18 connected to a forward end of the series-connected joint axes 3-9. The manipulator 1 is enabled to make the hand 18 positioned at a control target by operations of the respective joint axes 3-9.

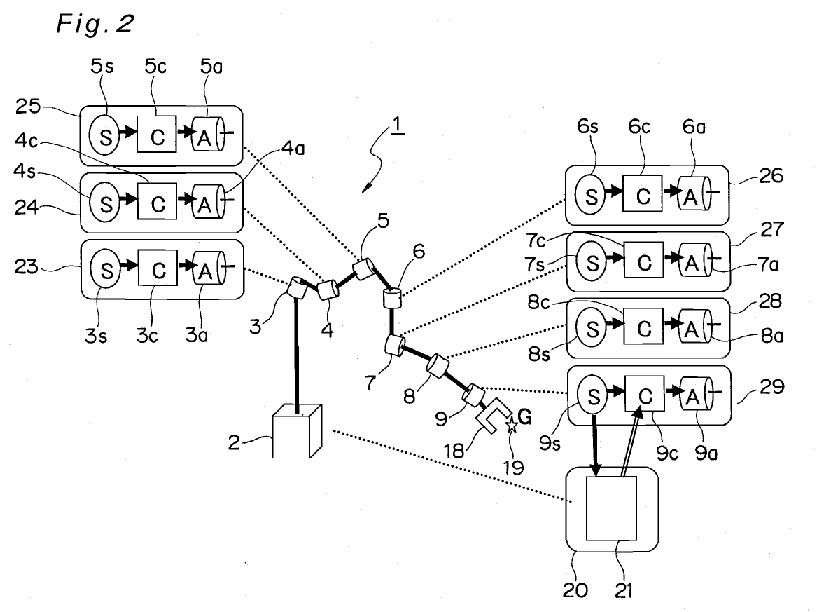

FIG. 2 is a schematic view of a control system of the first embodiment. The control system performs operation control for the respective joint axes 3-9 to exert control for making the hand 18 of the manipulator 1 positioned at a control target 19 (G). As shown in FIG. 2, the control system of the manipulator 1 includes joint control sections 23-29 for controlling drive operations for the joint axes 3-9, respectively, on a joint-to-joint basis, and a total evaluation section 20 which is an example of a total control section for performing evaluation of the total operation of the manipulator 1.

The joint control section 23 includes a measuring device 3s having an encoder or other like sensor and serving for performing measurement of states (joint displacement and joint velocity) of the joint axis 3, and an actuator 3a for driving the joint axis 3. The joint control section 23 also includes a control computation processing device 3c which creates, by computations, information for performing drive control of the actuator 3a based on information inputted from the measuring device 3s and the total evaluation section 20 to perform drive control of the actuator 3a independently of the other joint axes 4-9. It is noted that the measuring device 3s and the actuator 3a are provided on the joint axis 3. Like the joint control section 23, the joint control sections 24-29 also include measuring devices 4s-9s, actuators 4a-9a, and control computation processing devices 4c-9c, respectively. The total evaluation section 20 includes a total evaluation processing device 21.

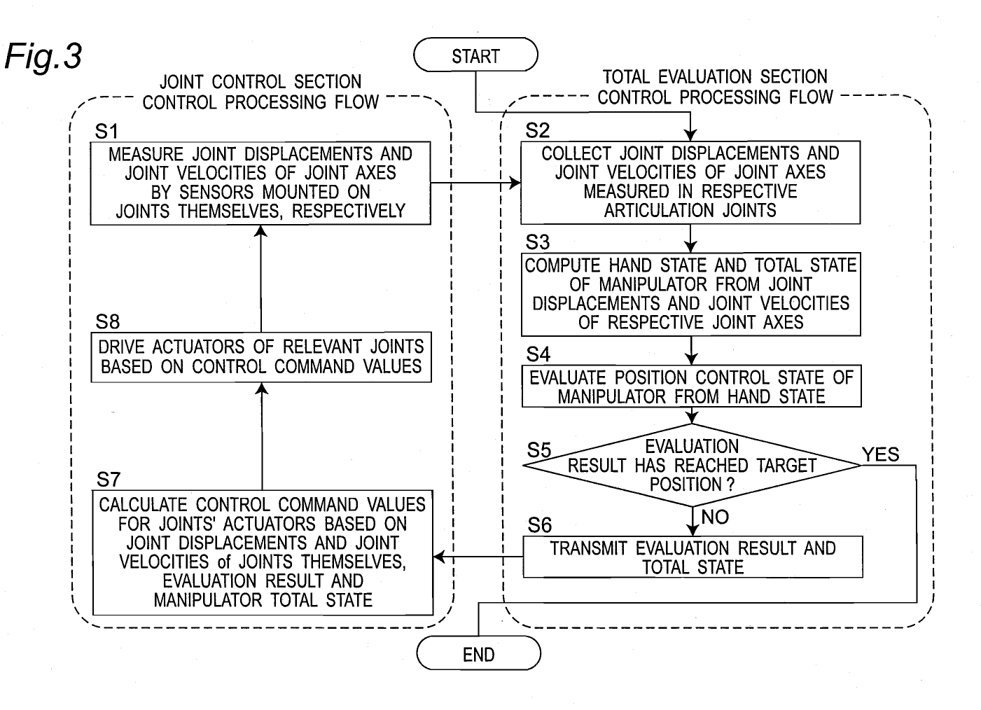

FIG. 3 is a chart showing a control processing flow of the first embodiment. In FIG. 3, the control processing flow in the total evaluation section 20 and the control processing flow in the joint control sections 23-29 are shown dividedly, with associations therebetween given therein.

In the control processing flow of FIG. 3, at step S1, joint displacements and joint velocities of the individual joint axes 3-9 are measured by the measuring devices 3s-9s included in the joint control sections 23-29 of those joint axes, respectively. Next, at step S2, information as to the measured joint displacements and joint velocities of the joint axes is transmitted from the joint control sections 24-29 of the joint axes 3-9 to the total evaluation section 20, thus being collected therein. Thereafter, at step S3, a state of the hand 18 of the manipulator 1, as well as its total state variables (total state), are calculated by using the information as to the joint displacements and joint velocities of all the joint axes 3-9. Subsequently, at step S4, a position control state of the manipulator 1 is evaluated from the state of the hand 18 (first step). Thereafter, at step S5, it is decided with reference to an evaluation result whether or not the hand 18 of the manipulator 1 has reached the control target (target position) 19. If the hand 18 has not reached the control target 19, the evaluation result and the total-state information are transmitted to each of the joint control sections 23-29 at step S6 (second step).

Next, at step S7, based on the evaluation result and the total-state information as to the manipulator 1 transmitted from the total evaluation section 20, as well as on the joint-displacement and joint-velocity information as to the joints of the joint control sections' own (information measured at step S1), control command values (correction values) for the actuators 3a-9a of the joints own are calculated in the joint control sections 23-29, respectively, independently of the other joint axes (third step). Subsequently, at step S8, based on the calculated control command values, the actuators 3a-9a of the joint control sections' own joints are driven. Thereafter, control processes of the steps S1-S8 are iteratively executed. At step S5, if it is decided from an evaluation result that the hand 18 of the manipulator 1 has reached the control target 19, position control of the manipulator 1 for the control target 19 is completed. It is noted that control processes of the steps S1, S7 and S8 are executed independently of one another by the joint control sections 23-29, respectively, while control processes of the steps S2-S6 are executed by the total evaluation section 20. A sampling time during which the processes of the steps S1-S8 are iterated in the total evaluation section 20 and the joint control sections 23-29 is set to a time period of 10 ms or less, e.g. a time period of about 1 ms. It is noted that such a sampling time setting is determined on a basis of the time taken for the hand 18 of the manipulator 1 to be brought closer to the control target.

As shown in the control processing flow of FIG. 3, a relationship of information delivery between the total evaluation section 20 and the individual joint control sections 23-29 is as follows. First, joint-displacement and joint-velocity information as to the joint axes is measured at step S1 by the joint control sections 23-29, respectively. Then, at step S2, the measured information is transmitted from the joint control sections 23-29, respectively, and collected by the total evaluation section 20. At step S6, an evaluation result and total-state information as to the manipulator 1 are transmitted from the total evaluation section 20 to the joint control sections 23-29, respectively. At step S7, in the joint control sections 23-29, respectively, with reference to the transmitted evaluation result and total state, control command values for the actuators are calculated.

A more concrete relationship between the individual control elements in the control system of the manipulator 1 shown in FIG. 2 and the control processing flow of FIG. 3 is as follows. First, the step S1 is executed by the measuring device 3s-9s, and the steps S2-S6 are executed by the total evaluation processing device 21. Further, the step S7 is executed by the control computation processing devices 3c-9c, and the step S8 is executed by the actuators 3a-9a.

In the step S5, in which it is decided as an evaluation result whether the hand 18 of the manipulator 1 has reached the control target 19, a decision criterion therefor is whether or not the hand 18 has reached within a specified range including the control target 19, in consideration of control width and errors in the position control.

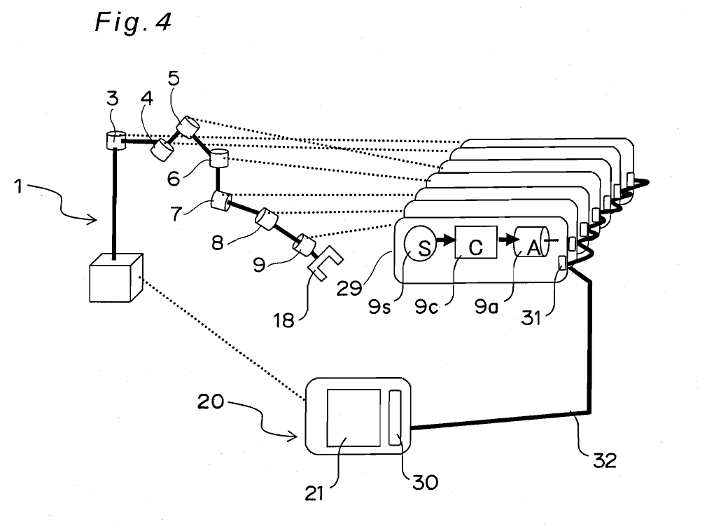

Now an outlined view of operation of the control system of this first embodiment is shown in FIG. 4.

Referring to FIG. 4, the total evaluation section 20 comprises the total evaluation processing device 21 for performing evaluation of a total control state of the manipulator 1, and a communication device 30 intercommunicatable with a plurality of control devices. Construction of the joint control section 29 of the joint axis 9 as a representative of the joint control sections 23-29 of the respective joint axes 3-9 is described below. The joint control section 29 comprises a control computation processing device 9c for measuring a joint displacement and a joint velocity of the joint axis 9 and calculating a control command value for the actuator 9a, the actuator 9a for driving the joint axis 9, and a communication device 31 communicatable with the communication device 30 contained in the total evaluation section 20. It is noted that the other joint control sections 23-28 also have a similar construction. Further, the communication device 30 in the total evaluation section 20 is connected to the communication devices (communication device 31 etc.) within the joint control devices 23-29 for the joint axes 3-9 via a network 32 which is a wire or wireless information communication means.

Concrete values, evaluation results and control computation methods to be computed in the individual processing steps in the control method of the first embodiment are set as follows as an example. First, in the control processing flowchart of FIG. 3, a state of the hand 18 to be computed in the step S3 of the total evaluation section 20 is assumed as position and velocity of the hand 18. Then, total state variables (total state) to be computed also in the step S3 of the total evaluation section 20 are assumed as velocity and Jacobian matrix of the hand 18. It is noted that in this first embodiment, the total state variables, i.e. velocity and Jacobian matrix of the hand 18, are information including joint displacements and joint velocities of the respective joint axes 3-9. Otherwise, the parameters of the hand 18 include position and velocity, and the parameters of the joint axes 3-9 include joint displacement and joint velocity.

Position of the hand 18 can be determined by substituting displacements of all the joints into the forward kinematic equation of Equation (1). Further, differentiating both sides of Equation (1) yields the following Equation (3):

V=Jω (3)

In Equation (3), V represents a velocity vector of the hand 18, J represents a Jacobian matrix, and ω represents a joint-velocity vector of an joint axis. Accordingly, substituting measured joint velocities of the joint axes into Equation (3) allows the velocity of the hand 18 to be calculated and the Jacobian matrix as well to be calculated simultaneously.

Further, an evaluation result computed in the step S4 of the total evaluation section 20 is given by a deviation vector that connects from the position (end position) of the hand 18 to the control target (target position) 19. this deviation vector is an example of the positional difference.

The deviation vector can be determined by the following Equation (4):

D=G−H (4)

In Equation (4), D represents a deviation vector, and G represents a position vector of the control target.

As the control method for the joint control sections 23-29, a change in a motion vector of the hand 18 due to a change in joint velocity of a targeted joint axis is considered. A velocity vector of the hand 18 created by the joint velocity of the targeted n-th joint (n-th joint axis) can be calculated by using Equation (3) as follows:

Vn=Jωn (5)

In Equation (5), Vn represents a velocity vector of the hand 18 created by the joint velocity of the n-th joint, and con represents a joint velocity vector of an joint axis which has zero velocity changes except the n-th joint element. Accordingly, the motion vector of the hand 18 resulting when the joint velocity of the n-th joint is accelerated or decelerated with a small velocity change a can be expressed by Equation (6) for acceleration and by Equation (7) for deceleration:

V+αn=J(ω+αn) (6)

V−αn=J(ω−αn) (7)

In Equation (6) and Equation (7), V+αn represents a velocity vector of the hand 18 for an acceleration of the n-th joint alone with a velocity change α, V−αn represents a velocity vector of the hand 18 for a deceleration of the n-th joint alone with a velocity change α, and an represents a joint velocity vector of an joint axis which has a velocity change α for the n-th joint alone with zero velocity changes for the other elements.

From Equations (3), (6) and (7), motion vectors of the hand 18 can be calculated for three cases that a current velocity is maintained, accelerated and decelerated, respectively. Therefore, using the following Equation (8), magnitudes of directional components of those deviation vectors are calculated:

C=V·D/|V|×|D| (8)

In Equation (8), C represents a magnitude per unit component of the deviation vector directional components, and it can be understood that given an angle φ formed by the directional vectors of V and D, C=cos φ, where the angle φ becomes smaller and smaller with increasing value of C so that the directions of V and D approach a coincidence with each other. Accordingly, values of C are determined for V, V+αn, and V−αn, respectively, and a joint velocity of the joint axis at which the value of C becomes largest, i.e. the velocity vector of the hand 18 becomes closest to the control target 19, is calculated as the control command value.

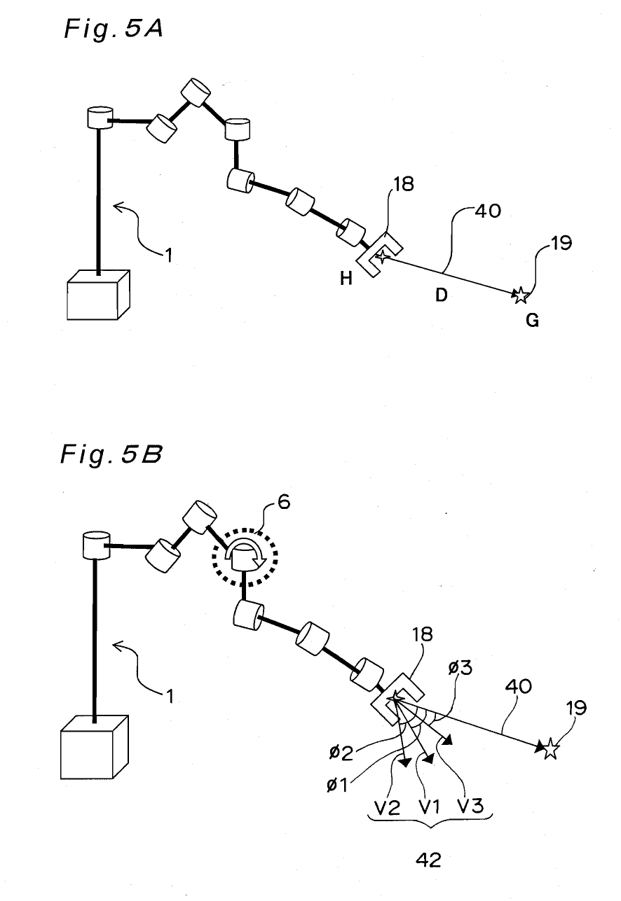

Next, a control method for the joint axes 3-9 by the joint control sections 23-29, respectively, is explained with reference to schematic views shown in FIGS. 5A and 5B. FIG. 5A is a schematic view showing a positional relation between the manipulator hand and the control target, and FIG. 5B is a schematic view showing a way of determining command values for the individual joint axes of the manipulator.

Referring to FIG. 5A, a deviation vector 40 (D) is a vector that connects from position (H) of the hand 18 of the manipulator 1 to position (G) of the control target 19.

Referring to FIG. 5B, with regard to an joint axis 6 (n-th joint), which is a controlled object, candidates for a velocity vector 42 of the hand 18 at a current velocity ω1 (ω1=ω), an accelerated velocity ω2 (ω2=ω+αn), and a decelerated velocity ω3 (ω3=ω−αn) are V1, V2, and V3, respectively. A joint velocity of the joint axis 6 is set based on values of angles φ1, φ2, and φ3 formed by the velocity vector 42 and the deviation vector 40. In the case of FIG. 5B, since the angle φ3 is the smallest, the velocity vector V3 is decided as closest to the deviation vector 40, so that the velocity vector V3 decelerated by a from the current velocity V is set as a control command value for the joint velocity.

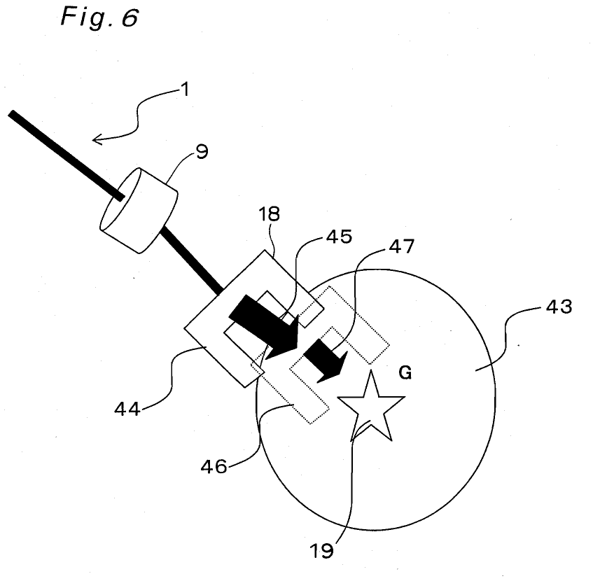

In the control method described above, without controlling the velocity of the manipulator 1 as a whole, i.e. without directly controlling the velocity of the hand 18, joint velocities of the respective joint axes 3-9 are set. Accordingly, there is a possibility that the velocity of the hand 18 may result in such an abnormally fast one as to lead to a dangerous state or a passage through the control target without stoppage. Thus, the velocity of the hand 18 is limited, for example, as shown in the schematic view of FIG. 6, by which the above-mentioned problems are solved.

FIG. 6 is a schematic view showing a way of setting an upper limit of the hand velocity of the manipulator in the first embodiment.

Referring to FIG. 6, in the total evaluation section 20, a deceleration region 43 within a specified range from the control target 19 is set. In this case, the deceleration region 43 may be either spherical or circular shaped. Depending on the control target 19 or the hand 18, the deceleration region 43 may be unidirectionally elongated. A velocity 45 of the hand 18 at a position 44 where the hand 18 is out of the deceleration region 43 is assumed as an upper-limit velocity of the hand 18, and the velocity is so controlled that the upper-limit velocity decreases more and more with decreasing distance between the hand 18 and the control target 19, with a setting that the velocity comes to 0 when the hand 18 reaches the control target 19. That is, the control is such that a velocity 47 of the hand 18 at a position 46 where the hand 18 is closer to the control target 19 within the deceleration region 43 is lower than the velocity 45 at the position 44. Further, a velocity ratio of the upper-limit velocity to a current velocity is added as a new evaluation result computed in the step S4 of FIG. 3, and if the velocity ratio of the upper-limit velocity to the current velocity is decided to be higher than 1 in the step S7 of FIG. 3, then a product of this velocity ratio and the joint velocity of a selected joint axis is assumed as a new control command value for the joint velocity of the joint axis.

With the addition of such processing, joint velocities of all the joint axes are consequentially decelerated in accordance with the upper-limit velocity, by which the hand 18 is so controlled that an upper limit of velocity of the hand 18 becomes the upper-limit velocity. As the upper-limit velocity declines with increasing closeness to the control target 19, the velocity of the hand 18 is decelerated more and more with increasing closeness of the hand 18 to the control target 19, so that the hand 18 can reliably be stopped at the control target 19.

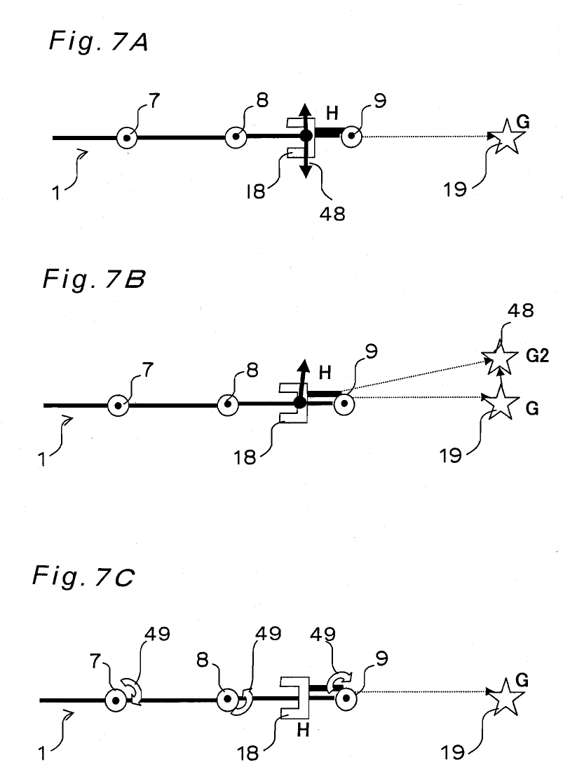

Another issue to be solved on the manipulator control lies in the singular posture of the manipulator. The term “singular posture” refers to an abnormal posture which causes an error in the manipulator control, it being an important issue of manipulator control how this state is avoided. For an explanation of the singular posture of the manipulator, schematic views showing management for the singular posture of the manipulator 1 in the first embodiment are shown in FIGS. 7A, 7B and 7C. In this case, FIG. 7A is a schematic view for explaining a problem when the manipulator has come into a singular posture, FIG. 7B is a schematic view showing a first management method for escape of the manipulator from the singular posture, and FIG. 7C is a schematic view showing a second management method for escape of the manipulator from the singular posture.

Referring first to FIG. 7A, the manipulator 1 is in such a posture that no matter how its joint axes 7-9 are driven, the velocity vector of its hand 18 is inevitably directed vertical to the control target 19, and a velocity vector cannot be created in a direction approaching the control target 19. Such a posture of the manipulator 1 is the “singular posture.” In this first embodiment, only with the control method that has been described hereinabove, when the manipulator 1 has come into a singular posture, the hand 18 would be stopped, kept from approaching the control target 19.

Therefore, in this first embodiment, the following two ways are exploited to enable the management for the singular posture, i.e., the escape from the singular posture. In this first embodiment, when joint velocities of all the joint axes 3-9 (joint axes 7-9 in FIG. 7A) have become zero despite the state that the hand 18 has not reached the control target 19 (within a specified range from the target position), it is decided that a singular posture has occurred. This can be decided, for example, depending on whether or not the joint velocity of 0 has been maintained for an arbitrary set time period or more in all the joint axes 3-9 in the step S4 of the total evaluation section 20 in FIG. 3.

First, as shown in FIG. 7B, the first management method is a method in which upon occurrence of a singular posture of the manipulator 1, a temporary control target 48 (G2) shifted from the original control target 19 (G) is set only for an arbitrary set time period in the step S4 of the total evaluation section 20. After the setting of the temporary control target 48 and the computation of deviation vectors, which are evaluation results, the deviation vectors are transmitted to the joint control sections 23-29, respectively, as evaluation results. Based on the transmitted deviation vectors, control for the move of the hand 18 going toward the temporary control target 48 is performed in the joint control sections 23-29, by which the manipulator 1 can be escaped from the singular posture. Upon elapse of an arbitrary set time after the escape from the singular posture, the original control target 19 is set once again, followed by continued normal control.

Next, the second control method is a method in which the presence or absence of a singular posture is added as a new evaluation result computed in the step S4 of the total evaluation section 20 in FIG. 3, where the presence or absence of a singular posture is transmitted from the total evaluation section 20 to each of the joint control sections 23-29. On condition that any singular posture has occurred, the control target 19 is temporarily dissociated from the target, and the joint axes 3-9 are subjected to arbitrary joint-velocity swinging operations 49 for an arbitrary set time period by the joint control sections 23-29, respectively, as shown in FIG. 7C, thus being forced to escape from the singular posture by the execution of the swinging operations 49. Upon elapse of an arbitrary set time after the escape from the singular posture, the original control target 19 is set once again, followed by continued normal control.

The first embodiment has been described above on a case where evaluation results and the total-state information are transmitted from the total evaluation section 20 to all the joint control sections 23-29 (step S6 of FIG. 3). However, the first embodiment is not limited to only such a case. Instead, for example, the information may be transmitted only to joint control sections that control controlled-object joint axes out of the joint axes 3-9.

According to the control method by the control system of the manipulator 1 of the first embodiment, the following various effects can be obtained.

In the control method of the first embodiment, information as to an evaluation result of the total state of the manipulator 1 prepared in the total evaluation section 20 is transmitted to the individual joint control sections 23-29, and then based on the evaluation result information, control command values of the joint control sections' own joints are prepared in the joint control sections 23-29, respectively, independently of the other joint axes. As a result, joint axis basis control exerted independently toward the control target 19 makes it possible to achieve position control. Thus, there occurs neither the problem that the control command value involved in inverse kinematics cannot be uniquely determined nor the problem due to large quantities of computations, even in the manipulator 1 having redundancy or nonlinear drive elements. Also, since there is no need for setting constraint conditions for the computation of inverse kinematics or for limiting the degree of freedom, the control can be carried out while a high degree of freedom is maintained. Furthermore, since the training of operations is unnecessary as well, the manipulator control can be carried out with ease.

Moreover, even if some of the joint axes are disabled from operation due to effects of the ambient environments or failures of the joint axes, the redundancy is naturally exercised by the other joint axes going independently toward the control target 19, making it possible to achieve the position control in a state of robustness against the ambient environments or joint failures. It is noted that the term, robustness, refers to a property that the system characteristics are capable of maintaining functions of the status quo against uncertain variables such as disturbance or design errors. Further, the term ‘failure’ herein refers to a state that an joint axis does not operate regardless of a control command issued to the joint axis because the joint control section that performs operation control for the joint axis or the total evaluation section has not recognized the occurrence of any problem with the objective joint axis.

Furthermore, such problems as an excessive velocity of the hand 18 due to the joint axis basis computation of control command values or a passage of the hand 18 through the control target 19 can be solved by the velocity control of the hand 18 performed by the total evaluation section 20 or the like. Also, the singular posture of the manipulator 1 can be managed by temporarily setting a temporary control target or making swinging operations executed by the total evaluation section 20.

Thus, according to the manipulator control method of the first embodiment, position control can be carried out in a state of robustness against the ambient environments or joint failures, so that the position control can be achieved with ease even if redundancy or nonlinear drive elements are involved.

Further, the control method of the first embodiment, which uses the same control rules even with the manipulator changed in configuration or joint count, is enabled to manage such changes in configuration or joint count only by changing configurational parameters of the manipulator.

### Second Embodiment

The present invention is not limited to the foregoing first embodiment, and may be embodied in other various modes. A manipulator control method according to a second embodiment of the invention is described below.

In actual scenes of use of the manipulator, there is a need for flexible management of various working operations. For this purpose, although the configuration or joint count of the manipulator may be changed depending on the working operation, yet the control method of this second embodiment can be exploited in order to eliminate the need for preparing programs or rewriting programs in accordance with the configuration or joint count of the manipulator. As a result of this, even changes in the configuration or joint count of the manipulator can be managed only by parameter changes, allowing the manipulator to be added and changed to a robot or the like for immediate use in a plug-and-play like fashion.

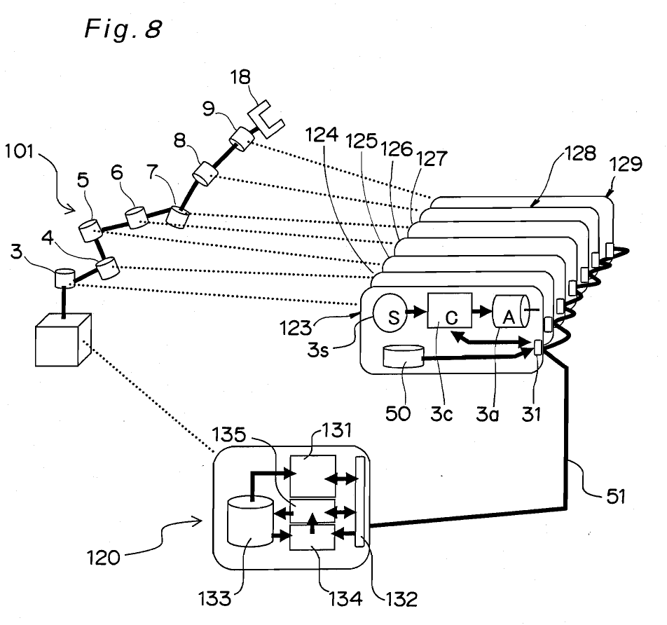

Hereinbelow, a method for achieving addition and changes of the manipulator in plug and play is described with reference to the accompanying drawings. FIG. 8 shows a schematic view of a manipulator control system of the second embodiment of the invention.

Referring to FIG. 8, the control system for a redundant manipulator 101 includes a total evaluation section 120 for performing total evaluation of the manipulator 101, and joint control sections 123-129 for independently performing control for the joint axes, respectively.

The total evaluation section 120 comprises an evaluation computation device 131, a communication device 132, a storage device 133 for storing therein, as data, such joint information as identification information and morphological information concerning each of the joint axes 3-9 included in the manipulator 101 under the current control, a monitoring device 134 for monitoring changes in connection states of the joint axes 3-9 constituting the manipulator 101 based on the data stored in the storage device 133, and a joint information updating device 135 for, upon detection of a change in the connection states by the monitoring device 134, updating the data stored in the storage device 133 into changed joint information.

Since the joint control sections 123-129 have a similar construction, construction of the joint control section 123 as a representative is described below. The joint control section 123 includes a measuring device 3s, a control computation processing device 3c, an actuator 3a, a communication device 31, and a storage device 50 for storing therein such joint information as identification information and morphological information as to the joint of the joint control section's own.

In this case, the joint axis identification information stored in the storage device 50 of the joint control section 123 is, desirably, identification information unique from joint axis to joint axis as an example. Then, adding this identification information to communication data transmitted by the communication device makes it possible to discriminate whether or not communication data has been derived from the joint axis. In addition to this, the identification information can be specified as an address of commands from the total evaluation section 120 to the joint axes 3-9, so that the respective joint control sections 123-129 can exert control for their own joints only when identification information coincides with those joints' own identification information.

The communication device 132 of the total evaluation section 120 and the communication device 31 of the joint control section 123 are connected to each other via a network 51. The network 51 may be, for example, a network connected to the joint control sections 123-129 in the same order as the connection in the manipulator 101, which starts from the total evaluation section 120 and terminates by the joint axis 9 located at the forward end of the manipulator 101. With such a connection, the connection states of the individual joint axes 3-9 can be easily grasped by using the routing of the network 51. It is noted that the connecting method of the network 51 is not limited to such a method, and other methods may be used. In such a case, for example, detecting a connection state between adjoining joint axes and putting the connection state onto the network 51 as data allows the connection states of the individual joint axes to be grasped.

Identification data and connection states detected in this way are normally monitored through a comparison with the joint information concerning the manipulator 101 stored in the storage device 133 by the monitoring device 134 in the total evaluation section 120, where a difference, if any, is detected as a change in the connection states. Also, the joint information stored in the storage device 133 is updated by the joint information updating device 135 with use of joint information collected from the joint axes 3-9.

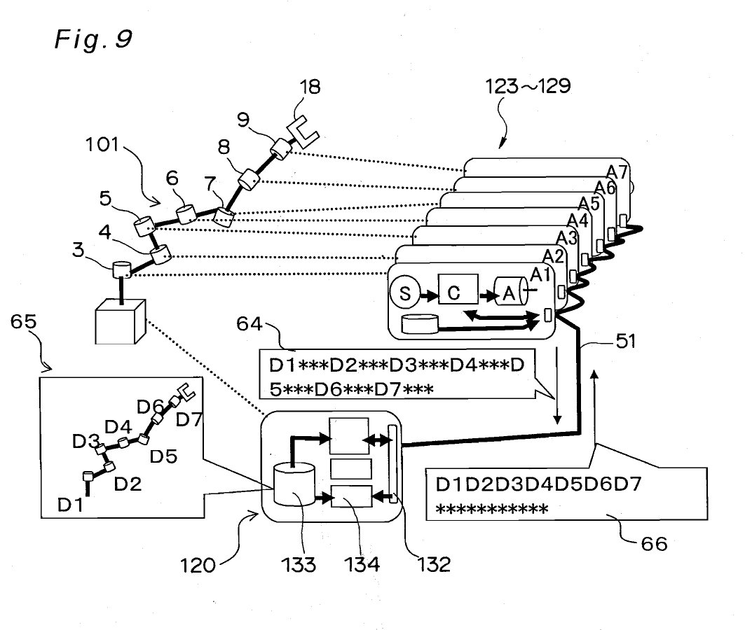

Next, a method for changing a component element of the manipulator 101 by plug and play is described with reference to the schematic views of the manipulator 101 shown in FIGS. 9 to 13.

First, FIG. 9 is a schematic view showing a state prior to a change in a component element of the manipulator.

Referring to FIG. 9, in the total evaluation section 120, identification information concerning the joint axes and connection information using routing or the like contained in communication information 64 concerning the joint axes 3-9 transmitted from the joint control sections 120, respectively, are compared with joint information data 65 stored in the storage device 133. In addition to this, total evaluation is performed in the total evaluation section 120, joint axes that make control objects are set based on the joint information data of the storage device 133, and communication information 66 including those joint axes' identification information is transmitted to their corresponding joint control sections 123-129. Those joint control sections 123-129 perform control of their own joints only when the communication information 66 contains identification information as to the joint control sections' own joints. It is noted that in FIGS. 9 to 13, for an easier understanding of the explanation, the joint control sections 123-129 that perform control of their corresponding joint axes 3-9 are denoted by A1-A7, respectively, while identification information concerning the respective joint axes 3-9 is denoted by D1-D7. Also, a joint control section of an joint axis which is a component element changed as will be described later is denoted by A8, while its identification information is denoted by D8.

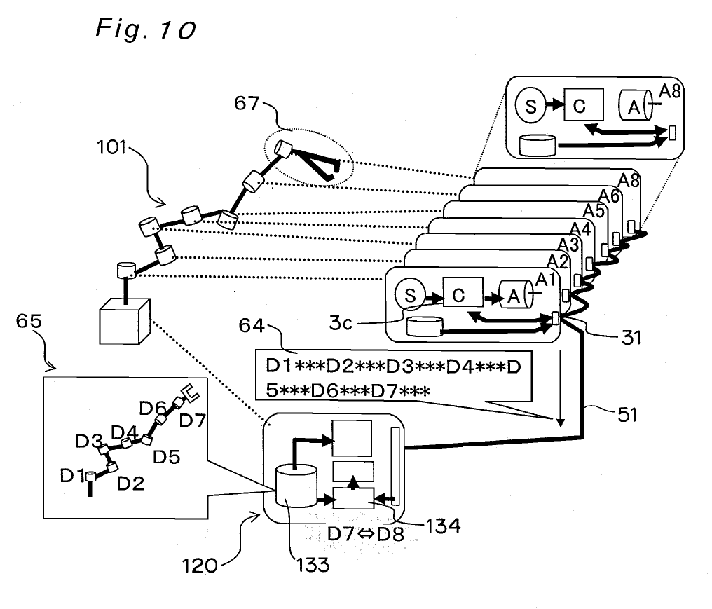

FIG. 10 is a schematic view showing a state after a change in the component element of the manipulator and until a detection of the changed point.

Referring to FIG. 10, an example is explained below on a case where an end portion (hand and joint axis) 67 of the manipulator 101 is changed from the joint axis associated with identification information D7 to that of identification information D8 as an example. The moment that an joint axis is changed, the joint control sections (123 etc.) transmit data collected as usual by the control computation processing devices (3c etc.) for the respective joint axes to the total evaluation section 120 as the communication information 64. In this case, however, since a change of the component elements has been made, different identification information D8 is contained in the communication information 64. In the total evaluation section 120, a comparison of the communication information and its routing or the like with joint information stored in the storage device 133 is made by the monitoring device 134. As a result of execution of this comparison, a difference of the identification information as to the end portion 67 is detected, by which it is detected by the monitoring device 134 that the manipulator 101 has been subjected to a change of its component elements.

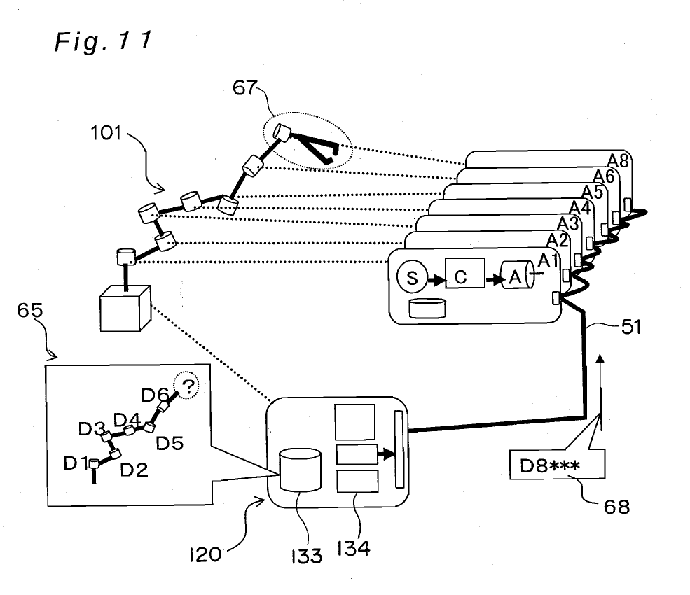

FIG. 11 is a schematic view showing a state in which a parameter inquiry to the joint control sections is going on.

Referring to FIG. 11, a change of the end portion of the manipulator 101 is detected by the monitoring device 134, and the total evaluation section 120 that has discovered an unidentified part within the joint information data 65 transmits communication information 68, which bears a demand for joint information, to an joint axis having the identification information D8, which bears unknown new morphology or the like of the end portion 67.

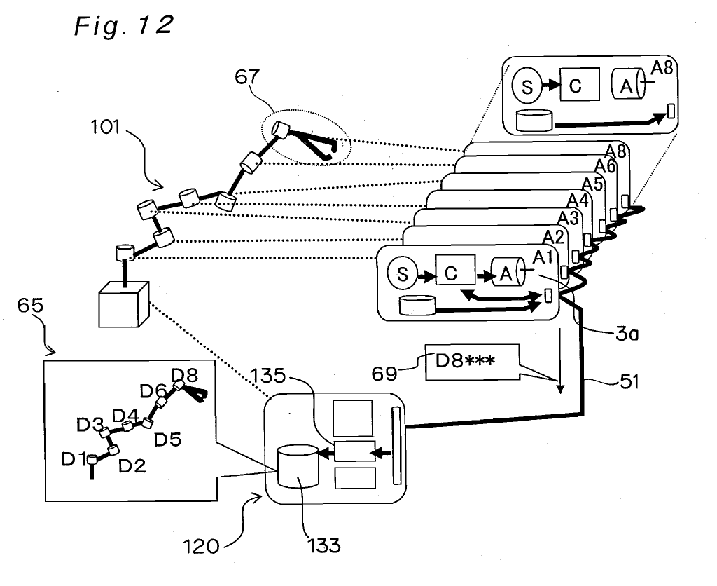

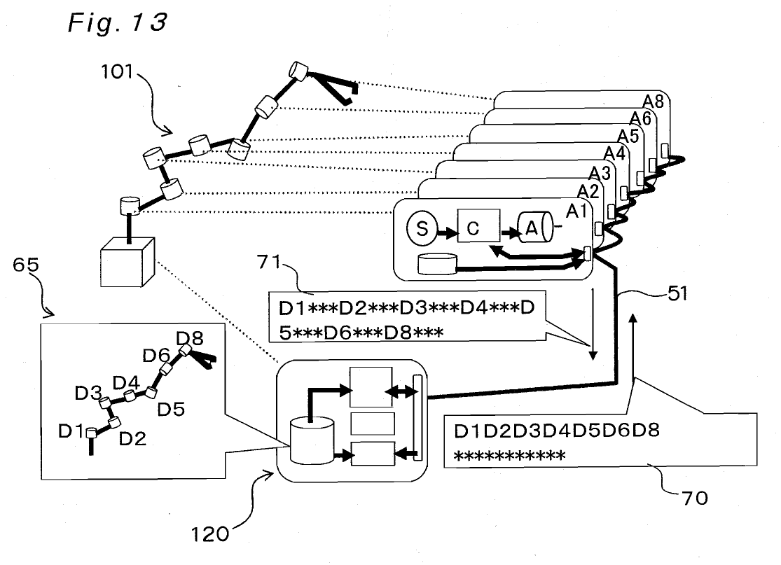

FIG. 12 is a schematic view showing a state in which a parameter response from the joint control sections is going on. FIG. 13 is a schematic view showing a state in which normal control is carried out under recognition of a constituent-element change in the manipulator.

Referring to FIG. 12, among the joint control sections A1-A8 (except A7) that have received the communication information 68 including the identification information D8, only the joint control section A8 having the identification information D8 makes a reaction, returning communication information 69 including morphological information concerning the joint control section's own joint to the total evaluation section 120. The total evaluation section 120, upon reception of this communication information 69, updates the joint information data 65 stored in the storage device 133 by using the joint information updating device 135. It is noted that the joint control section A8 associated with the identification information D8 has not yet done the actuator control until this time point.

Referring to FIG. 13, once the change result is registered in the joint information data 65 stored in the storage device 133, the total evaluation section 120 performs the computation of total evaluation according to the new joint information data 65, transmitting its result as communication information 70. This communication information 70 contains identification information on which the after-change constitution has been reflected, where by this identification information, the joint control section A8 associated with the identification information D8 and having not yet done the actuator control is caused to start the control as the other joint control sections A1-A6. This is followed by transmission of data 71 collected as usual by the measuring devices of the respective joint axes, and the total evaluation section 120 iteratively performs monitoring and control based on the data 71.

According to the manipulator control method described above, control is carried out on unified control rules regardless of the configuration and joint count of the manipulator, while parameters can be updated by autonomous detection of the construction of the manipulator. Therefore, even when the manipulator is subjected to a change of its component elements, control can be carried out in a plug-and-play fashion, i.e., continuously and safely. Thus, the manipulator can be easily changed in its configuration and joint count depending on working operation, hence its flexible and simple adaptability to a wider variety of operations.

### Third Embodiment

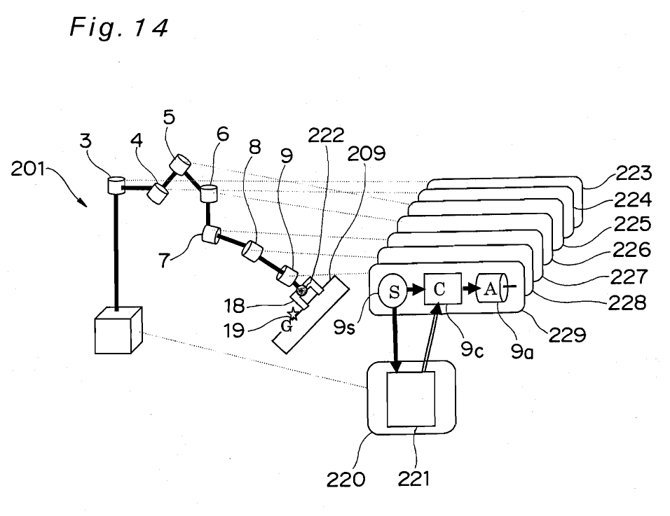

Next, a control method by a manipulator control system according to a third embodiment of the invention is described with reference to a schematic view of the manipulator control system shown in FIG. 14.

As shown in FIG. 14, the control system of a manipulator 201 in this third embodiment includes joint control sections 223-229 for controlling their respective joint axes 3-9, independently of the other joint axes, and a total evaluation section 220 for performing evaluation of the total state or the like of the manipulator 201.

Each of the joint control sections 223-229 includes a measuring device (9s etc.) having an encoder or other sensor mounted on each of the joint axes 3-9, an actuator (9a etc.) for driving its corresponding joint axis, and a control computation processing device (9c etc.) for calculating a control command value for the actuator based on input information. The total evaluation section 220 includes a total evaluation processing device 221.

The control method for the manipulator 201 in this third embodiment is a method in which under the exertion of position control for moving the hand 18 of the manipulator 201 toward the control target 19, force control is performed so as to hold a constant contact force applied from the hand 18 to a working object 209. In order to fulfill such force control, the hand 18 is equipped with a force measuring device 222 for measuring contact force.

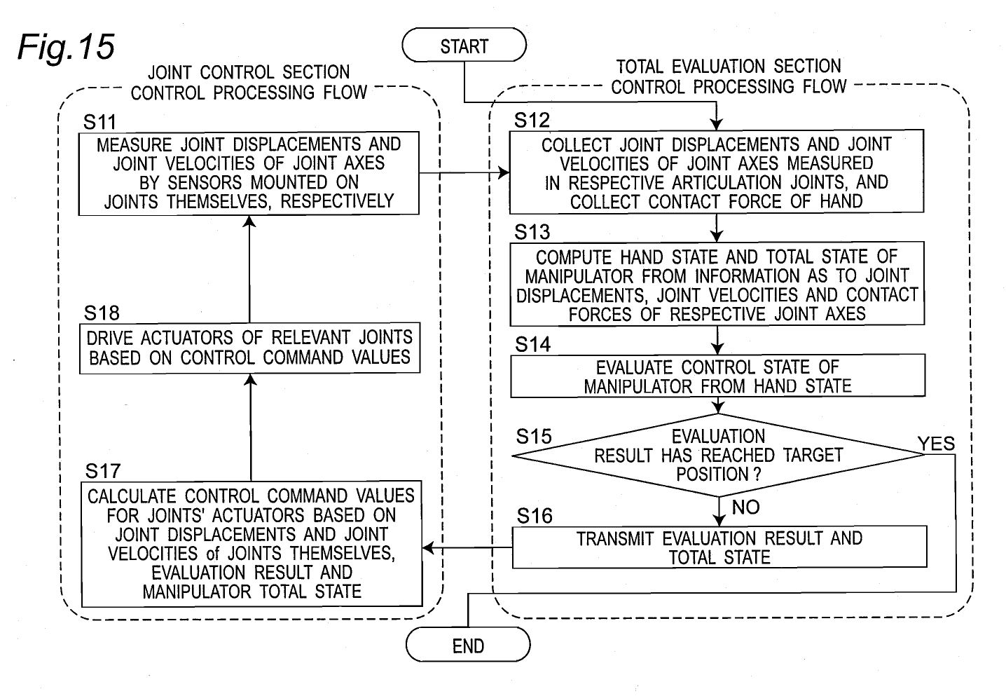

FIG. 15 shows a control processing flow for position control and force control for the manipulator 201 by the control system having such a construction as shown above.

As shown in FIG. 15, at step S11, joint displacements and joint velocities of the individual joint axes 3-9 are measured by the measuring devices (9s etc.), respectively. Next, at step S12, information as to the measured joint displacements and joint velocities is transmitted from the joint control sections 223-229 to the total evaluation section 220, thus joint-displacement and joint-velocity information being collected. In addition to this, the contact force of the hand 18 being in contact with the working object 209 is measured by the force measuring device 222 and collected in the total evaluation section 220. Thereafter, at step S13, a state of the hand 18 and a total state variable (total state) are computed from the joint-displacement and joint-velocity information as to the joint axes 3-9 as well as the contact force information as to the hand 18. Subsequently, at step S14, a control state of the manipulator 201 is evaluated based on the state of the hand 18 (first step). It is noted that details of the evaluation method for the control state, i.e. position control and force control, will be described later. Thereafter, at step S15, if it is decided based on the evaluation result that a control target has not yet been reached, the evaluation result and the total-state information are transmitted from the total evaluation section 220 to each of the joint control sections 223-229 at step S16 (second step).

In each of the joint control sections 223-229, at step S17, based on the joint-displacement and joint-velocity information as to the joint control section's own joint, as well as on the transmitted evaluation result and the manipulator total-state information, a control command value for the joint control section's own actuator is calculated independently of the other joint axes (third step). Subsequently, at step S18, based on the calculated control command value, the actuator of the relevant joint is driven. Control processes of these steps S11-S18 are iteratively executed. At step S15, if it is decided from the evaluation result that the hand 18 of the manipulator 201 has reached the control target (target position and target contact force), the position control and force control for the manipulator 201 is completed. It is noted that the control processes of steps S11, S17 and S18 are executed independently of one another by their corresponding joint control sections 223-229, respectively, while the control processes of steps S12-S16 are executed by the total evaluation section 120.

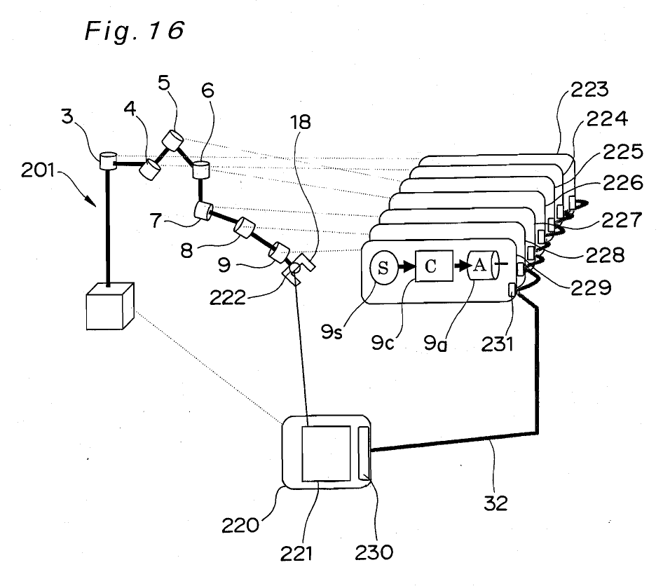

FIG. 16 shows an outline view of operation of the control system in the third embodiment.

Referring to FIG. 16, the total evaluation section 220 comprises a total evaluation processing device 221 for performing evaluation of the total control state of the manipulator 201, and a communication device 230 intercommunicatable with a plurality of control devices. Also, construction of the joint control section 229 for the joint axis 9 as a representative of the joint control sections 223-229 for the joint axes 3-9, respectively, is described below. The joint control section 229 comprises a control computation processing device 9c for measuring a joint displacement and a joint velocity of the joint axis 9 and calculating a control command value for the actuator 9a, the actuator 9a for driving the joint axis 9, and a communication device 231 communicatable with the communication device 230 contained in the total evaluation section 220. It is noted that the other joint control sections 223-228 are similar in construction to the joint control section 229. Further, the communication device 230 in the total evaluation section 220 is connected to the communication devices (communication device 231 etc.) within the joint control sections 223-229 for the joint axes 3-9 via a network 232 which is a wire or wireless information communication means.

Concrete values, evaluation results and the control computation method to be computed in the individual processing steps in the control method of the third embodiment are set as follows as an example. First, in the control processing flow of FIG. 15, a state of the hand 18 to be computed in the step S13 of the total evaluation section 220 is assumed as position and velocity of the hand 18 as well as contact force of the hand 18. Then, total state variables (total state) to be computed also in the step S13 of the total evaluation section 220 are assumed as velocity, contact force and Jacobian matrix of the hand 18. It is noted that in this third embodiment, the total state variables, i.e. velocity, contact force and Jacobian matrix of the hand 18, are information including joint displacements and joint velocities of the respective joint axes 3-9. Further, in the third embodiment, the parameters of the hand 18 are velocity and contact force.

Position of the hand 18 of the manipulator 201 can be determined by substituting joint displacements of all the joint axes 3-9 into Equation (1).

Further, substituting measured joint velocities of the joint axes 3-9 into Equation (3) allows the velocity of the hand 18 to be calculated and the Jacobian matrix as well to be calculated simultaneously.

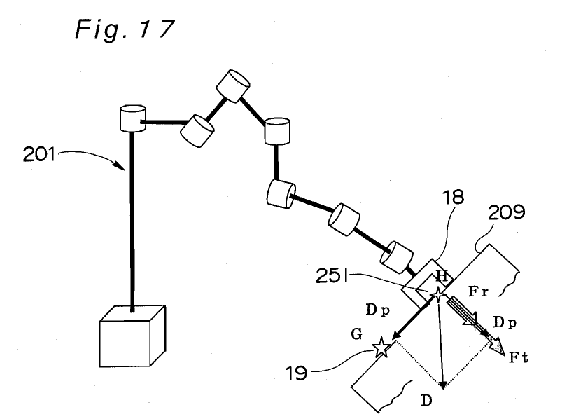

Further, an evaluation result computed in the step S14 of the total evaluation section 220 is computed as shown in FIG. 17 as an example. First, a deviation vector that connects from hand position 251 to position of a control target 18. In addition, a position deviation vector Dp can be determined by Equation (9). It is noted that G represents the position vector of the control target 19.

Dp=G−H (9)

Next, a contact force difference between a contact force Ft of the control target and an actual contact force Fr, i.e. a positional deviation equivalent to the force difference, is calculated. A resultant force-equivalent deviation vector Df can be expressed as shown in Equation (10). It is noted that Kf represents a control gain, for which an appropriate value is selected by the system.

Df=Kf(Ft−Fr) (10)

By using the position deviation vector Dp and the force-equivalent deviation vector Df represented by above Equations (9) and (10), respectively, a total deviation vector D to be used for control evaluation is calculated as shown by Equation (11):

D=Dp+Df (11)

After the calculation of the total deviation vector D by Equation (11) as shown above, by a procedure similar to that of the position control method of the first embodiment, motion vectors of the hand 18 in three cases, i.e. a case of maintaining the current velocities of the joint axes 3-9 (V), a case of acceleration (V+αn), and a case of deceleration (V−αn), as well as magnitudes C of directional components of the respective deviation vectors, are calculated by using Equations (3), (5), (6), (7) and (8). With reference to results of the calculation, a joint velocity for each joint axis at which C becomes the largest, i.e. the velocity of the hand 18 becomes closest to the direction of the control target, is adopted as the control target.

With respect to this control target, control for the n-th joint is carried out, as shown by Equation (12), as such control that a torque (Tn+ΔTn), which is a result of adding ΔTn to a current output torque Tn, is outputted:

ΔTn=Mn·Δωn/Δt+Kdn·Δωn (12)

where Δn represents a velocity difference between the selected control target of joint velocity for the n-th joint and the current joint velocity, and Δt represents a control unit time. It is assumed that Mn is a moment of inertia of the n-th joint and Kdn is a viscosity resistance component of the n-th joint. Using the control torque output (Tn+ΔTn) calculated in this way makes it possible to calculate such a control command value of the joint velocity for the n-th joint that the arrival of the hand 18 at the target position as well as the generation of the target contact force can be achieved more effectively.

According to the manipulator control method exemplified by the above-described solutions, even when one joint axis is disabled from motion due to effects of the ambient environments or joint failures, the redundancy is naturally exerted by the other joints being independently directed toward the control target. Therefore, the position control and force control can be carried out while the robustness is held against ambient environments and joint failures. Thus, there can be provided a control method and a control system for the manipulator capable of, even with redundancy and nonlinear drive elements involved, easily and flexibly achieving the control independently of uncertainties of the ambient environments, joint failures and the like.

This third embodiment has been described on a case where position control and force control for the hand of the manipulator 201 are performed in combination, as an example. However, instead of such a case, the control method of the third embodiment can be considered applicable also to cases where only the force control is performed.

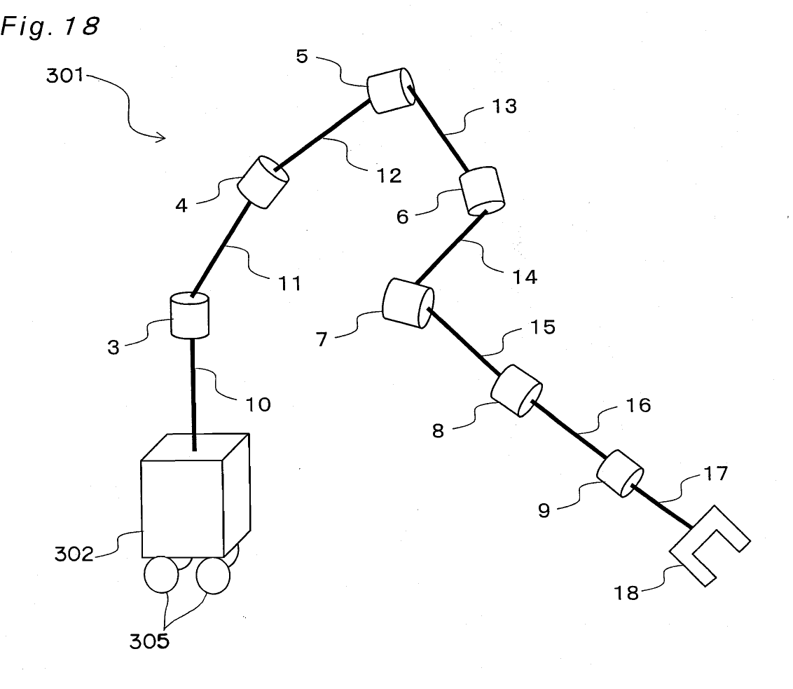

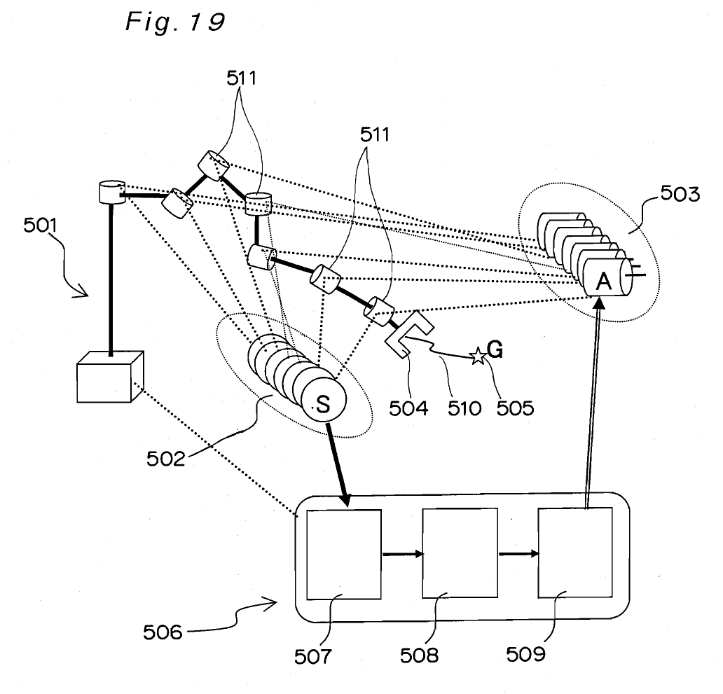

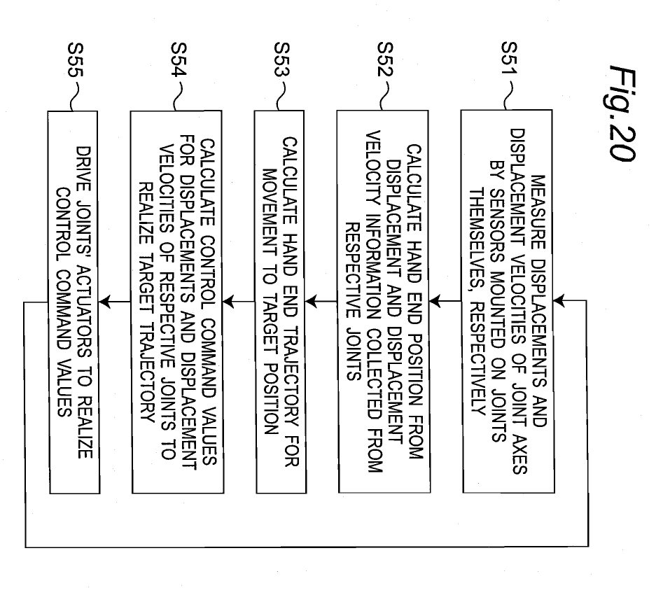

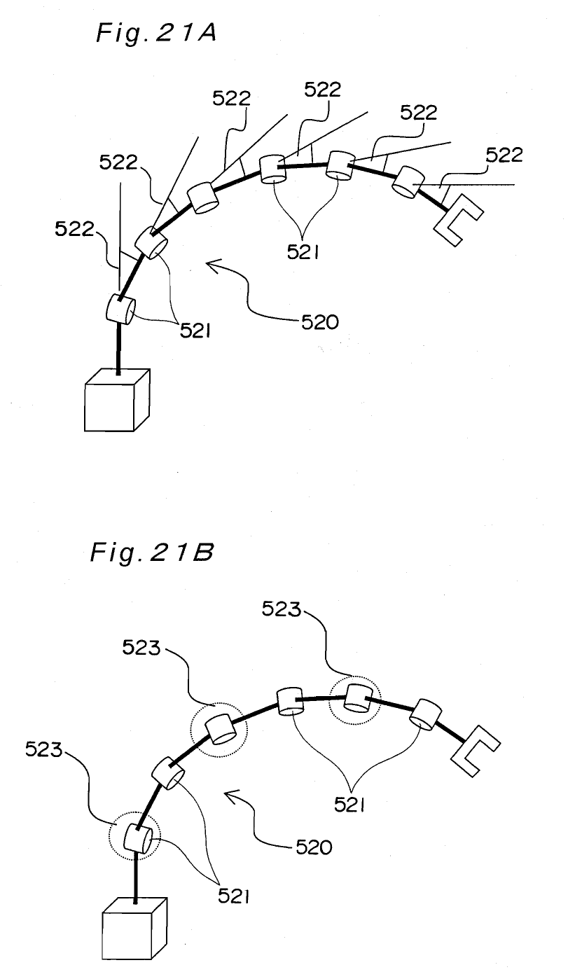

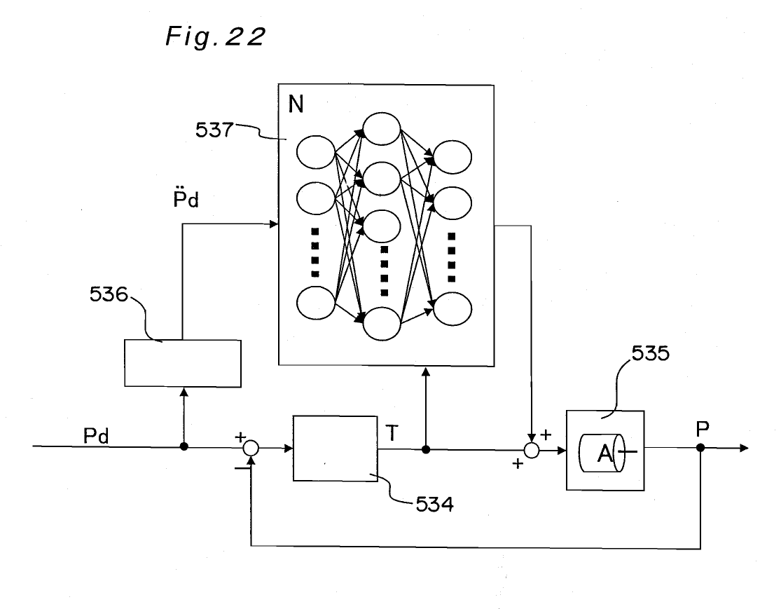

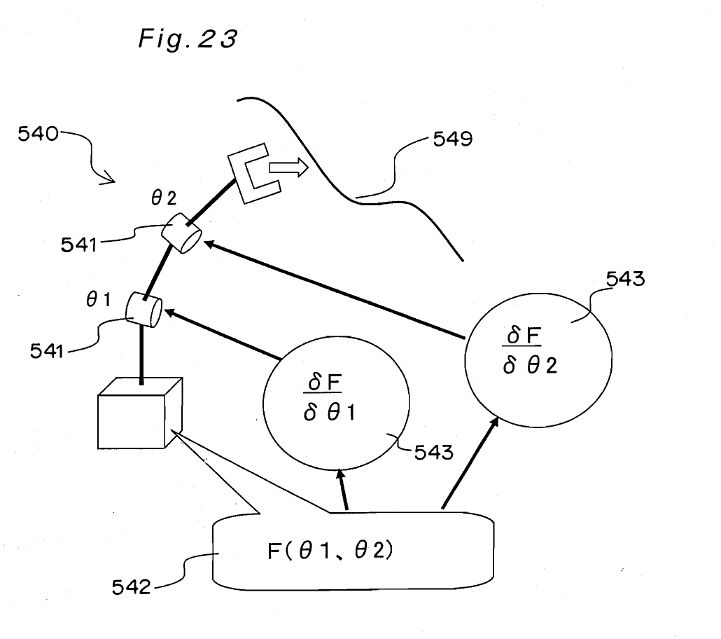

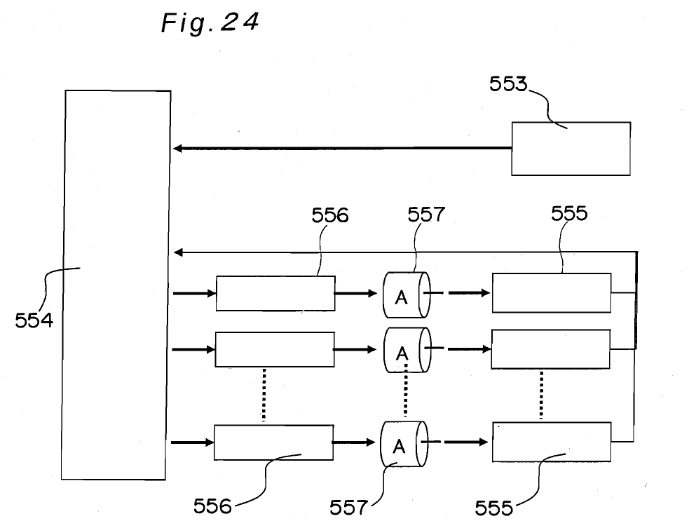

The foregoing embodiments have been described on a case where the manipulator 1 or the like is controlled for its operation under the state that the base 2 for supporting the arm portion of the manipulator 1 or the like is fixed at one position. However, the present invention is not limited to such cases only, and the invention allows adoption of, for example, such a construction as shown in the schematic view of FIG. 18 in which a base 302 for supporting the arm portion of a manipulator 301 is equipped with a moving device 305 using wheels or the like so that the installation place of the manipulator 301 is movable.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2006-082269 filed on Mar. 24, 2006, including specification, drawings, and claims are incorporated herein by reference in its entirety.

### INDUSTRIAL APPLICABILITY

According to the control method and the control system for manipulators in the present invention, there can be realized position control having a robustness and capable of achieving the control even with uncertainties and variations of the ambient environments or joint failures or the like. Since the control method and the control system are capable of easily and flexibly achieving the position control by using less numbers of sensors even with redundancy or nonlinear drive elements involved, those control method and control system can be applied to industrial- and consumer-use robot arms or the like dedicated to working operations being more complex and requiring higher degrees of freedom. In particular, those control method and control system are useful for applications to household robots which involve the presence of many obstacles as well as many environments in which their locations are indeterminate.

1. A control method of a manipulator having a plurality of joint axis, comprising:
a 1st process to measure a difference between a present value and a target value for an end portion of the manipulator;
a 2nd process to transmit joint information including joint displacements and joint velocities of the joint axes, and difference information, to joint control sections of the joint axes, respectively; and
a 3rd process to adjust parameters of the joint axes independently of one another by the joint control sections, respectively, based on the joint information and the difference information, wherein
the 1st-3rd processes are repeated until the parameter of the end portion reaches to within a set range including the target value.

2. A control method of a manipulator having a plurality of joint axes, comprising:
a 1st process to measure a positional difference between an end position of the manipulator and a target position;
a 2nd process to transmit joint information including joint displacements and joint velocities of the joint axes, and positional difference information including positional difference, to joint control sections of the joint axes, respectively; and
a 3rd process to adjust the joint displacements and the joint velocities of the joint axes independently of one another by the joint control sections, respectively, based on the joint information and the positional difference information, wherein
the 1st-3rd processes are repeated until the end position reaches to within a set range including the target position.

3. The control method of a manipulator as defined in claim 2, wherein
based on the information as to the joint displacements and joint velocities acquired from the joint axes, the joint information including joint displacements and joint velocities of the joint axes, and
thereafter, the 2nd process is done.

4. The control method of a manipulator as defined in claim 2, wherein
in the 2nd process information including a Jacobian matrix computed by using the joint displacements and the joint velocities as well as an end velocity of the manipulator is transmitted on the joint axis, while information as to a deviation vector of the end position with respect to the target position is transmitted as the positional difference information,
in the 3rd process, by using the end velocity, the joint velocities of the joint axes, and the Jacobian matrix, a motion vector for the end position is computed based on the joint velocity vectors of the joint axes, and the joint velocity vector is adjusted on the joint axis basis so that the motion vector approaches the deviation vector.

5. The control method of a manipulator as defined in claim 2, wherein
in the 2nd process, information including information as to a velocity ratio of an upper-limit value of an end velocity to an actual end velocity, the end velocity being set in correspondence to a distance between the end position and the target position, is transmitted to the joint axes, and
in the 3rd process, the joint velocities are adjusted in response to the velocity ratio by the plurality of joint control sections.

6. The control method of a manipulator as defined in claim 3, wherein
when all of acquired joint velocities of the joint axes are 0, the position of the target position or the joint velocity is temporarily changed, and
thereafter, the 2nd process is done.

7. The control method of a manipulator as defined in claim 2, wherein
acquired identification information as to joints owned by the joint axes is unified, by which a change in connection states of the joints is detected.

8. The control method of a manipulator as defined in claim 2, wherein after identification information as to the joints is transmitted from the total control section to the joint control sections, control of the joint axes is done in the joint control sections only when previously stored identification information as to the joint control sections' own joints coincides with the transmitted identification information.

9. A control method of a multi-jointed manipulator, comprising:
a 1st process to measure a force difference between a contact force applied to an end portion of the manipulator and a target contact force;
a 2nd process to transmit joint information including joint displacements and joint velocities of the joints, as well as force difference information, to joint control sections, respectively; and
a 3rd process to, based on information including joint displacements and joint velocities of the joints as well as on information including force difference, adjust the joint displacements and the joint velocities of the joint axes in the joint control sections, wherein
the 1st-3rd process are repeated until the contact force applied to the end portion reaches to within a set range including the target contact force.

10. The control method of a manipulator as defined in claim 9, wherein
based on the information as to the acquired joint displacements and joint velocities of the joints, the information including the joint displacements and the joint velocities of the joints is prepared; and
thereafter, the 2nd process is done.

11. The control method of a manipulator as defined in claim 9, wherein
in the 1st process, a positional difference between a position of the end portion and a target position is further measured,
in the 2nd process, information including a Jacobian matrix computed by using the joint displacements and the joint velocities as well as information including an end velocity of the manipulator is transmitted to the joints, while information as to a deviation vector of the end portion with respect to the target position and a target contact force is prepared, and information as to a total difference which is a result of adding to the positional difference an equivalent positional difference obtained by equivalently converting the force difference into a positional difference is transmitted, and
in the 3rd process, by using the end velocity, the joint velocities of the joint axes, and the Jacobian matrix, a motion vector of the end position is computed based on the joint velocity vectors of the joint axes, and the joint velocity vectors are adjust so that the motion vector approaches the deviation vector.

12. A control system of a manipulator having a plurality of joint axes, comprising:
a measuring device to measure a difference between a present value and a target value for an end portion of the manipulator;
a total control section to control the manipulator based on the difference information and information including joint displacements and joint velocities of the joint axes;
a transmission device to transmit evaluation result information as to the control from the total control section to the joint axes; and
a plurality of joint control sections which are provided on the joint axes, respectively, to adjust parameters of the joint axes independently of one another of the joint axes based on the transmitted evaluation result information thereby controlling driving of the joint axes.

13. A control system of a multi-jointed manipulator, comprising:
a measuring device to measure a positional difference between an end position of the manipulator and a target position;
a total control section to control a position of the manipulator based on information including positional difference and information including joint displacements and joint velocities of the joint axes;
a transmission device to transmit the position control information from the total control section to the joints; and
a joint control sections which are provided on the joints, respectively, to adjust the joint displacements and the joint velocities of the joint axes independently of one another of the joint axes based on the transmitted position control information thereby controlling driving of the joint axes.

14. The control system of a manipulator as defined in claim 13, wherein the total control section comprises:
a storage device to storage therein joint information including identification information or morphological information as to the joint axes;
a monitoring device to monitor connection states of the joint axes based on the joint information stored in the storage device; and
a joint information updating device to update the joint information stored in the storage device when a change in the connection states of the joint axes is detected by the monitoring device.

15. The control system of a manipulator as defined in claim 13, wherein each of the joint control sections comprises:
a storage device to storage therein joint information including identification information or morphological information as to the joint axes; and
a communication device to notify the total control section of the joint information stored in the storage device by any of the joint axes being connected to another joint axis.

16. A control system of a multi-jointed manipulator, comprising:
a measuring device to measure a force difference between a contact force applied to an end portion of the manipulator and a target contact force;
a total control section to perform torque control for the manipulator based on information including force difference and information including joint displacements and joint velocities of all the joint axes;
a transmission device to transmit the torque control information from the total control section to the joints; and
a plurality of joint control sections which are provided on the joints, respectively, to adjust the joint displacements and the joint velocities of the joint axes independently of one another of the joint axes based on the transmitted torque control information thereby controlling driving of the joint axes.
